(19) United States
(12) Patent Application Publication
(10) Pub. No.: US 2016/0016351 A1
(43) Pub. Date: Jan. 21, 2016

(54) METHOD AND APPARATUS FOR PRODUCING CONTAINER CARRIER WITH A ROTARY DIE PRESS

(71) Applicants: Paul S. Siewert, Arlington Heights, IL (US); Rachell L. SLOVIK, Bartlett, IL (US); Christopher J. LUDWIG, Buffalo Grove, IL (US)

(72) Inventors: Paul S. Siewert, Arlington Heights, IL (US); Rachell L. SLOVIK, Bartlett, IL (US); Christopher J. LUDWIG, Buffalo Grove, IL (US)

(21) Appl. No.: 14/799,197

(22) Filed: Jul. 14, 2015

Related U.S. Application Data
(60) Provisional application No. 62/026,303, filed on Jul. 18, 2014.
(60) Provisional application No. 62/134,416, filed on Mar. 17, 2015.

(51) Int. Cl. B29C 53/02

(52) U.S. Cl. CPC B29C 53/02; B29L 2031/7162

(57) ABSTRACT

A flexible carrier for carrying a plurality of containers within a plurality of corresponding container receiving apertures is formed using a rotary die within a rotary die press resulting in carriers having complex configurations including close tolerance cuts and complex perforation patterns.

### PRIORITY CLAIM

This application claims priority to U.S. Provisional Applications, Ser. No. 62/026,303, filed on 18 Jul. 2014, and Ser. No. 62/134,416, filed on 17 Mar. 2015. These U.S. Provisional Applications are hereby incorporated by reference herein in their entirety and are made a part hereof, including but not limited to those portions which specifically appear hereinafter.

### BACKGROUND OF THE INVENTION

1. Field of the Invention

This invention relates to a flexible carrier for carrying a plurality of containers manufactured using a rotary die.

2. Description of Prior Art

Conventional container carriers are often used to unitize a plurality of similarly sized containers, such as cans, bottles, jars and boxes and/or similar containers that require unitization. Flexible plastic ring carriers are one such conventional container carrier.

Flexible plastic ring carriers having a plurality of container receiving apertures that each engage a corresponding container may be used to unitize groups of four, six, eight, twelve or other suitable groups of containers into a convenient multipackage.

Typically, flexible ring carriers are manufactured in a generally continuous string by feeding an extruded sheet of plastic material, such as low density polyethylene through a vertically reciprocating punch press. As a result, traditional presses punch discrete rows of carriers in which each carrier is connected to adjacent carriers within a row. Depending on the size of the carrier being formed, and the width of the web of carrier material, a plurality of rows may be formed simultaneously in the web of material. To minimize problems associated with indexing variation as the web of material passes through the punch press, adjacent rows of carriers have been punched spaced from each other. As the web passes out of the punch press, the carriers are provided in discrete rows, and are subsequently wound onto separate supply reels or spools or fan folded into boxes.

Marketing demands have tended toward the packaging of more containers in a single package. As a result, there is a demand for larger carriers, such as, for example, twelve-pack carriers in which two arrays of six container receiving apertures are provided on each side of a central web. Even with relatively small containers, a two row twelve-pack carrier of this type is significantly long.

For speed and efficiency in manufacture, it is common to punch at least one entire carrier with each stroke of the press, and index the web forward by at least one carrier length in preparation for the next stroke. As the length of the carriers increases, the indexing stroke increases, and errors in indexing are magnified. An additional problem is that the punched rows of carriers can “wander” exiting the punch press, resulting in misalignment of the unpunched portion of the web, and malformation of portions in subsequent carriers punched in the web.

As can be appreciated, the location, size and shape of the container receiving apertures for holding the containers are critical to proper functioning of the carrier. An undersized, oversized, wrongly located, or malformed container receiving aperture may inadequately retain a container, allowing the container to fall from the carrier. Failure of a carrier in the automatic machinery attaching a carrier to the containers can cause significant difficulties, and significantly curtail output. Failure during transport of the assembled package, at best, is inconvenient

As partially described above, punch presses have speed limitations; are noisy; require costly dies; require sophisticated indexing; and are limited in the shapes that can be punched at high speeds. There is therefore a need for an alternative method of manufacture for such plastic ring carriers.

### SUMMARY OF THE INVENTION

The present invention is directed to a flexible carrier for packaging containers that is manufactured using a rotary die and a rotary die press. According to preferred embodiments of this invention, a sheet of plastic material is directed through a rotary die press and three or more rows or “lanes” of container carriers are formed in a generally continuous manner.

The resulting carrier may include complex detail, close tolerance cuts, complex perforation patterns, including non-linear perforations, all with less scrap. Indexing complex multi-lane container carriers is also no longer an issue with the invention as described herein.

### BRIEF DESCRIPTION OF THE DRAWINGS

The above-mentioned and other features and objects of this invention will be better understood from the following detailed description taken in conjunction with the drawings wherein:

FIG. 1 is a side view of a rotary die press according to one preferred embodiment of this invention;

FIG. 2 is a side elevational view of a carrier produced in accordance to one preferred embodiment of this invention;

FIG. 3 is a side elevational view of a carrier produced in accordance to one preferred embodiment of this invention;

FIG. 4 is a side elevational view of a carrier produced in accordance to one preferred embodiment of this invention; and

FIG. 5 is a side elevational view of a carrier produced in accordance to one preferred embodiment of this invention.

### DESCRIPTION OF PREFERRED EMBODIMENTS

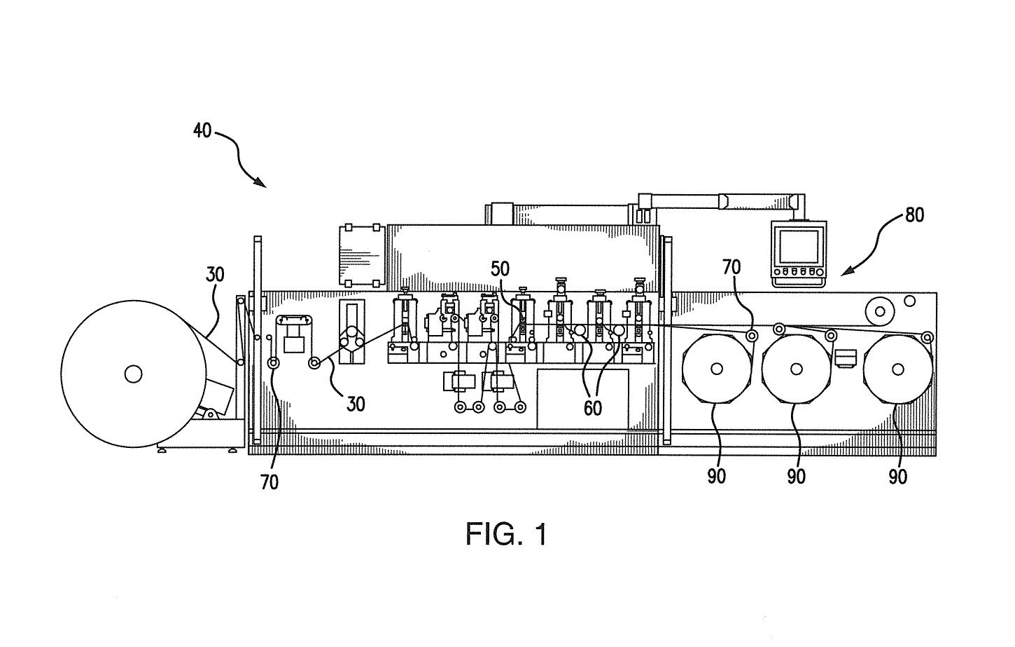

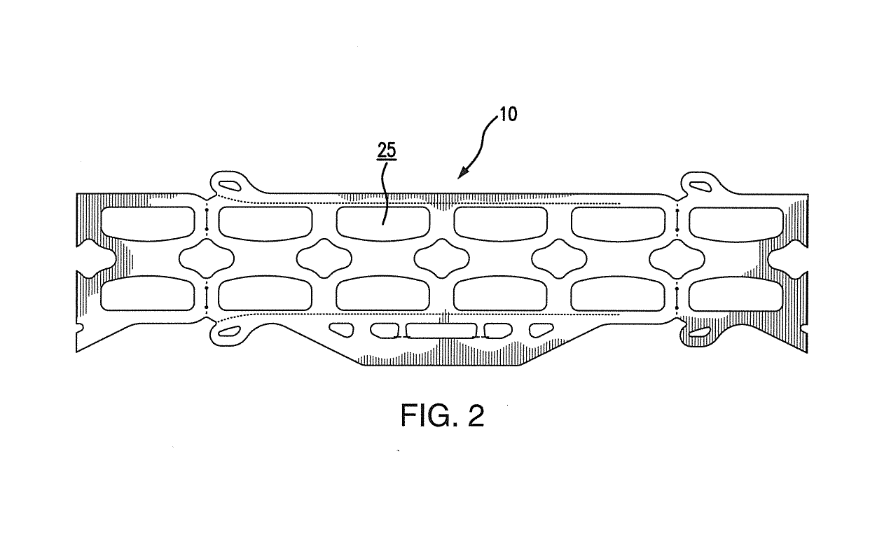

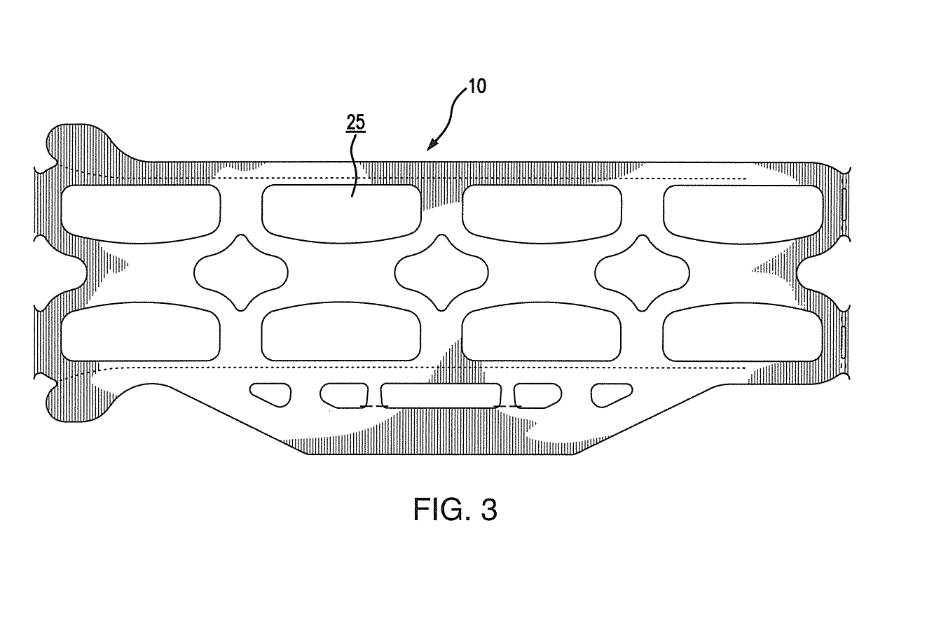

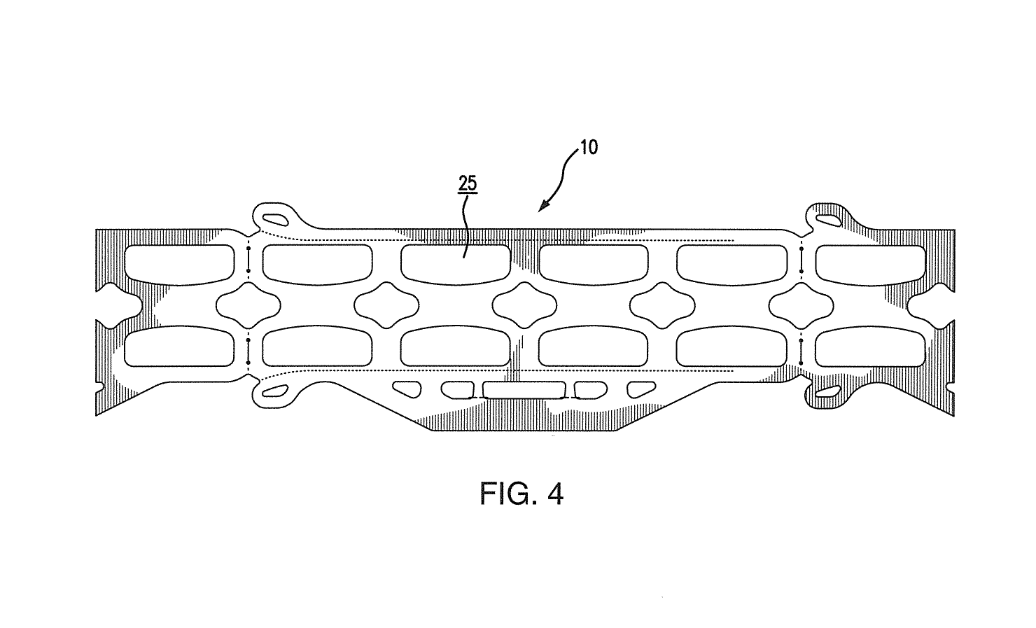

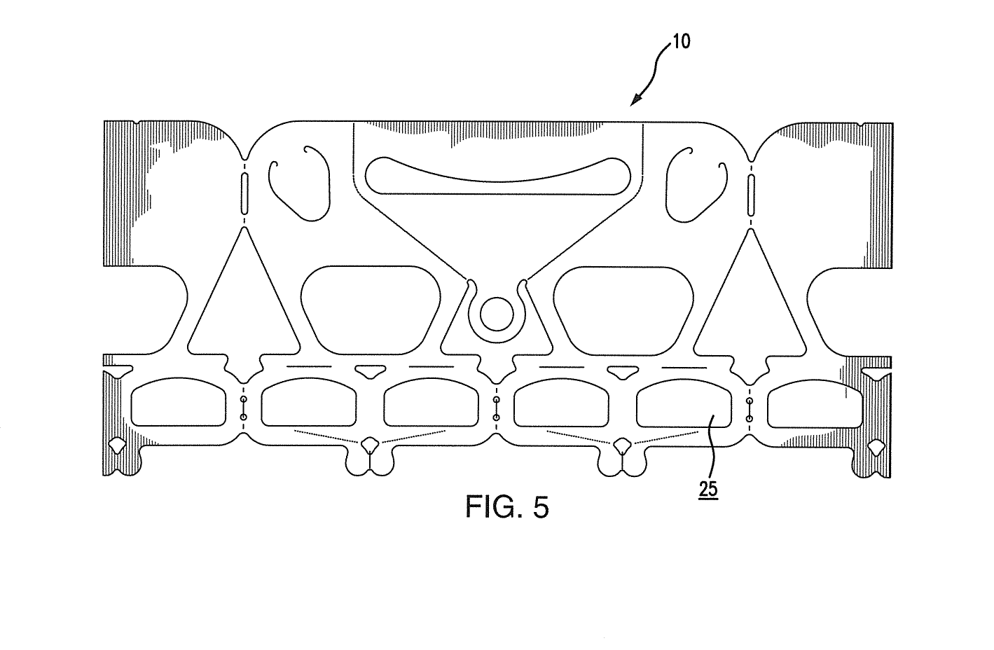

FIG. 1 shows a side view of a rotary die press for forming a plurality of flexible containers and a resulting unitized package. FIGS. 2-5 show flexible carriers 10 manufactured with the rotary die according to embodiments of this invention. However, the drawing is exemplary, and the invention is not limited to the flexible carriers 10 shown. For example, the flexible carrier 10 may be alternatively configured and used to unitize six, eight or any other desired number of containers.

Each flexible carrier 10 manufactured in accordance with the present invention preferably includes one or more layers of a flexible sheet 30 having a width and length defining therein a plurality of container receiving apertures 25, each for receiving a container. The plurality of container receiving apertures 25 are preferably arranged in longitudinal rows and longitudinal ranks so as to form an array of container receiving apertures 25, such as two rows by four ranks for an eight container multipackage as shown in FIGS. 2-4. The container receiving apertures 25 are preferably generally rectangular, elongated, circular, oval or other preferred shapes, as shown in FIG. 2-5, however, all container receiving apertures 25 generally include one or more radiused corners.

According to one preferred embodiment of this invention, such as shown in FIG. 1, one or more layers of a generally continuous roll of flexible plastic sheet 30 are fed into a rotary die press 40 to form the carrier 10 through a rotary die 50. The rotary die 50 cuts a desired configuration of the carrier and one or more waste modules extract and remove resulting slugs from the process. Such carriers are preferably formed in three or more rows or “lanes” of container carriers and are formed in a generally continuous manner.

A preferred embodiment of the rotary die 50 used in accordance with this invention is manufactured using D2 hardened tool steel but can be manufactured from a variety of tool steels and powdered metal alloys. Such rotary dies 50 are preferably single piece dies and include one or more curved blades forming a periphery and internal detail features of the container carriers 10 to be cut. Such detail features may be positioned in close proximity to each other in the rotary die 50 and may include tightly radiused corners, non-linear perforations, cuts formed right up to a periphery of the carrier and closely adjacent details.

The resulting carrier 10 may include complex detail, close tolerance cuts, complex perforation patterns, including non-linear perforations, all with less scrap. Indexing complex multi-lane container carriers is also no longer an issue with the invention as described herein. Various embodiments of such carriers are shown in FIGS. 2-5.

The rotary die press 40, as shown in FIG. 1, preferably includes an infeed 45 for the plastic sheet 30; a rotary die 50 for forming a generally continuous string of carriers 10 from the plastic sheet 30; one or more winding and unwinding modules 70 for transferring the plastic sheet 30 and/or the generally continuous string of carriers 10 through the rotary die 50 at a desired speed and tension; one or more waste modules 60 for evacuating and redirecting scrap generated from the punching process; and an outfeed for transferring the generally continuous string of carriers from the rotary die press to a collection station 80, such as a reel stand for rolling spools or reels 90 of the generally continuous string of carriers or a box for fanfolding (not shown) the generally continuous string of carriers. As used herein, the term “module” may include an integrated feature of the rotary die press or a separate component for accomplishing the described purpose.

As shown in FIG. 1, the subject invention enables three simultaneous reels 90 of container carrier 10 to be processed and wound from a single sheet of material 30. The rotary die press 40 as described permits multiple lanes of container carrier 10 be formed in a footprint much smaller than traditional one and two lane punch presses.

In the above-described apparatus, a preferred method for manufacturing a flexible carrier may include moving a plastic sheet of material 30 through a rotary die press 40 at a desired speed and tension. As the plastic sheet of material 30 travels through the rotary die press 40, a plurality of slugs of material may be removed from the plastic sheet of material with a rotary die 50 to form a generally continuous web. During this die-cutting process, the tension within the generally continuous web may be controlled by a combination of rollers, feedback loops and load cells. At least three lanes of a generally continuous string of container carriers are preferably formed from the continuous web with the rotary die.

The resulting generally continuous string of container carriers are then preferably fanfolded into a carton (not shown) and/or wound onto reels 90 applying each lane of the at least three lanes of container carriers to a plurality of containers at a collection station. Subsequently, the container carriers may be applied to a plurality of containers to form individual multipackages. In one preferred embodiment of this invention, the rotary die press 40 may be positioned directly upstream of an applicating machine (not shown) for direct transfer and application of the generally continuous string of container carriers, without the need for intermediate collection in cartons and/or reels.

As described above, the slugs may be removed from the rotary die press 40 using one or more waste modules 60. In this manner, the subject invention is much different from traditional applications of rotary dies 50 in that the web and not the slugs are the desired result of the process. Traditionally, the slugs have been cut and retained in process and the web has been recycled for later regrind and/or disposal. Here, the slugs are the waste product formed during the process and the web is wound or fanfolded in the resulting generally continuous string of container carriers 10.

The package resulting from the flexible carrier 10 includes a plurality of unitized flexible containers. Flexible carriers 10 are generally applied to containers by stretching the flexible sheet surrounding the container receiving apertures 25 around containers, and requiring the stretched carrier 10 to recover, thereby providing a tight engagement.

While in the foregoing specification this invention has been described in relation to certain preferred embodiments thereof, and many details have been set forth for purpose of illustration, it will be apparent to those skilled in the art that the flexible carrier 10 and the rotary die and rotary die press are susceptible to additional embodiments and that certain of the details described herein can be varied considerably without departing from the basic principles of the invention.

1. A method for manufacturing a flexible carrier comprising:
moving a plastic sheet of material through a rotary die press;
removing a plurality of slugs of material from the plastic sheet of material with a rotary die to form a generally continuous web;
controlling a tension within the generally continuous web; and
forming at least three lanes of a generally continuous string of container carriers from the continuous web with the rotary die, wherein each container carrier of the generally continuous string of container carriers includes at least one of tight radii and non-linear perforations.

2. The method of claim 1 further comprising:
applying each lane of the at least three lanes of container carriers to a plurality of containers.

3. The method of claim 1 further comprising:
fanfolding the at least three lanes of the generally continuous string of container carriers into a carton.

4. The method of claim 1 further comprising:
removing the slugs from the rotary die press using one or more waste modules.

5. The method of claim 1 wherein the generally continuous string of container carriers are wound onto a reel.

6. The method of claim 1 further comprising:
transferring the generally continuous string of carriers from the rotary die press to a collection station.

7. The method of claim 1 wherein the rotary die includes one or more curved blades forming a periphery and internal detail features of the continuous string of carriers.

8. A method for manufacturing a flexible carrier comprising:
moving a plastic sheet of material through a rotary die press;
forming at least three lanes of a generally continuous string of container carriers with a rotary die by removing a plurality of slugs of material from the plastic sheet, wherein each container carrier of the generally continuous string of container carriers includes a plurality of non-linear perforations; and
transferring the generally continuous string of container carriers to a collection station.

9. The method of claim 8 further comprising:
controlling a tension of the generally continuous string of container carriers within the rotary die press.

10. The method of claim 8 further comprising:
applying each lane of the at least three lanes of container carriers to a plurality of containers.

11. The method of claim 8 further comprising:
fanfolding the at least three lanes of the generally continuous string of container carriers into a carton.

12. The method of claim 8 further comprising:
removing the slugs from the rotary die press using one or more waste modules.

13. The method of claim 8 wherein the generally continuous string of container carriers are wound onto a reel.

14. The method of claim 1 further comprising:
transferring the generally continuous string of carriers from the rotary die press to a collection station.

15. A method for manufacturing a flexible carrier comprising:
moving a plastic sheet of material through a rotary die press;
continuously controlling a tension of the plastic sheet of material as it is presented to and punched by a rotary die; and
forming at least three lanes of a generally continuous string of container carriers with the rotary die, wherein each container carrier of the generally continuous string of container carriers includes at least one of tight radii and non-linear perforations.

16. The method of claim 15 wherein the rotary die includes one or more curved blades forming a periphery and internal detail features of the continuous string of carriers.
